(19) United States
(12) Patent Application Publication
(10) Pub. No.: US 2002/0069244 A1
(43) Pub. Date: Jun. 6, 2002

(54) Message delivery system billing method and apparatus

(76) Inventors: John Blair, San Francisco, CA (US); Adrian Turner, Mountain View, CA (US)

Correspondence Address: DERGOSITS & NOAH LLP, Suite 1150, Four Embarcadero Center, San Francisco, CA, 94111, US

(21) Appl. No.: 09/922,337

(22) Filed: Aug. 3, 2001

Related U.S. Application Data
(63) Continuation-in-part of application No. 09/896,017, filed on Jun. 28, 2001.
(60) Provisional application No. 60/167,458, filed on Nov. 24, 1999.

(30) Foreign Application Priority Data
Nov. 22, 2000 (US) PCT/US00/32246

(51) Int. Cl. G06F 15/16

(52) U.S. Cl. 709/203

(57) ABSTRACT

An on-line product delivery and billing system for aggregating product content delivery and payment for a network of customers and content providers is described. A content provider dynamically creates product content from one or more suppliers. The content provider sets pricing levels for the product content and aggregates billing information for the one or more suppliers and provides the content and payment information to the customer. The customer is billed for product delivery based upon predefined customer parameters and usage. The customer is presented one bill for all publishers' content accessed over the network. Upon payment the content provider provides payment to the suppliers in accordance with pre-established terms and conditions. Alternatively, the customer pays the suppliers directly, using the network as a delivery, metering, and billing platform. The product content is modified for transmission to specific customer client devices.

### CROSS-REFERENCE TO RELATED APPLICATIONS

This application is a continuation-in-part application of U.S. application Ser. No. 09/896,017, entitled “METHOD AND SYSTEM FOR CONTINUOUS INTERACTIVE COMMUNICATION IN AN ELECTRONIC NETWORK”, filed on Jun. 28, 2001, and which is assigned to the assignee of the present application.

### FIELD OF THE INVENTION

The present invention relates generally to computer networks, and more specifically, to a system for sourcing, distributing, tracking and billing for data objects transmitted over a network.

### BACKGROUND OF THE INVENTION

The World Wide Web (“Web”) has evolved from first generation Web systems that simply provided information to client computers over the Internet through a Web browser program to second generation systems using application servers that provide dynamic, personalized information and powerfill back-end transaction processing.

Despite advances in client-server technologies, present Web-transaction systems do not provide a robust and efficient communication platform to support high performance and secure commercial transactions involving multiple parties. Present Web applications are still unreliable and can fail on even the slightest communications problem. Web-based applications are also slow compared to resident or dedicated client/server communications systems. Although server and client computer processing speeds are high, present Web browser communication models are typically unreliable, limited and inefficient. The fact that present Web-based applications are based upon a document transmission model represents a fundamental limitation that prevents robust and efficient extension into application or transaction based processing.

Electronic Commerce (“e-commerce”) has become a fundamental application for Web-based transaction models. The convenience of buying and selling products and services over the Internet has allowed producers and retailers to effectively globalize their potential markets. On-line business models have become successfully adapted to distribute all manner of products and services over the global network. With the use of networks to pay for such goods, commercial transactions are increasingly conducted entirely over the network. This new commerce model affects both traditional buyer-seller transactions and commercial business-to-business transactions. Automated billing procedures allow the transfer of money between computer applications. For this application, business rules are typically implemented on the sending and receiving computers, and filters are often used to correctly route the payment transaction.

Along with the wide distribution networks and the increased spread of potential customers, on-line retailers are faced with increased problems of product supply, customer billing, and account management. Present Web-based systems do not provide satisfactory support for account management and product delivery models. User dissatisfaction arises from the lack of speed and reliability, and the complexities of order management over a browser interface. Because the client's Web browser must download each part of an application each time it is invoked, accessing the e-commerce site and switching between screens is slow and synchronous in that the user must wait for each transaction to be processed before conducting another. Moreover, any network failure during a transaction can cause it to fail with unpredictable results. Furthermore, the lack of an interactive connection between the buyer and seller forces the seller to use e-mail for any outbound communication, adding an extra layer of communication and forcing the user outside of the Web-based system.

The variety of on-line products, services, and content data continues to increase, as does the number of sources for those products and data objects. Customers may desire to purchase a composite product that is made up from several different types of data objects. For example, a downloadable music video can comprise several different types of data, such as video data, music data, and text data. Today, customers cannot purchase such a composite product because of the Web's inability to securely and reliably aggregate and transmit the data to the customer—each data object provider (content provider) must typically provide their data component individually to the customer.

Another significant disadvantage is payment of network distributed products. If the product is to be paid for, each provider is also independently responsible for collecting payment for their portion of the product. In addition, from the customer perspective, each customer may have to deal with multiple publishers of data objects separately, which further adds to transaction complexity. Present e-commerce systems generally do not allow for the efficient aggregation, common delivery and common billing of products or data objects provided by multiple content or data providers to a customer or a group of customers. At present, there exists no common way for content providers to establish the rules by which they will make their content available to one or more customers. There is also no common way for customers to decide under which circumstances they will receive and be billed for the products that are comprised of data objects. These problems are further compounded when the product represents data that may be used by a client application, rather than directly perceived or used by an individual.

A further disadvantage of present e-commerce product delivery systems is that they do not allow for specialized delivery to specific client devices. Various different types of devices are presently available for accessing Web-based content, such as computers, cell phones, PDA's, and the like. Each has different download and playback capabilities that present delivery systems do not differentiate among. This prevents appropriate price discrimination on the basis of the content delivered to specific client devices. Present e-commerce product delivery systems also do not allow for specialized delivery to other computer applications, that may use or further process the received product.

### SUMMARY AND OBJECTS OF THE INVENTION

It is an object of embodiments of the present invention to provide a network-based system that allows for event-driven object sourcing, delivery and tracking to one or more users or application programs from one or more content providers.

It is a further object of embodiments of the present invention to aggregate data objects, such as digital product content, provided from several content providers into a single deliverable product to the user.

It is yet a further object of embodiments of the present invention to aggregate billing events and payment methods from several different content providers for a single user and several different users for a single content provider.

An on-line data object delivery and billing system for aggregating data object delivery and payment for a network of customers and providers is described. A data object provider dynamically generates data objects, in some cases combining these data objects with third party or supplier data objects. The data object provider makes the data objects available to one or more users after defining business rules, including pricing via a network. The user may also be a data object provider. A network operator or other type of central server tracks content data object delivery, aggregates billing information for the one or more content providers and provides the data objects and payment information to the user. The user also accesses the network or central server and selects content data objects, agreeing to the business rules, including pricing established by the content provider and specifying method for payment. This network may be publicly available to any user or data object content provider, or only select users or data object content providers, or any combination thereof. Upon receipt of payment the content provider provides payment to any entities that have supplied it with content data objects that formed part of the overall data object content delivered to the user. These supplier payments are made in accordance with pre-established terms and conditions. In this case the content provider is acting as an intermediary between its supplier and the ultimate user of the data objects. Both the content provider and the user can choose to automate any of these steps. The product content is modified for transmission to specific customer client devices.

In one embodiment, the customer accesses the content directly from the originator of the data objects with no intermediary. In this case, the customer provides payment to the supplier in accordance with pre-arranged terms via a billing network. In an alternative embodiment, the customer accesses the content through an intermediary, in which case the intermediary collects the finds owed and then reimburses the suppliers via the billing network. A combination of the direct and indirect distribution and payment methods are also possible in further alternative embodiments of the present invention. The content provided to the customer may be transformed or altered, such as edited to facilitate playback on a particular type of client device (e.g., cell phone or PDA), or the content may be provided in an unmodified form for all customer client devices.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1A illustrates a switching network according to one embodiment of the present invention that couples a data object content provider (publisher) to a customer client computer, or user (subscriber);

FIG. 1B illustrates a switching network according to one embodiment of the present invention that couples a data object content provider (publisher) to a plurality of customer client computers, or users (subscribers);

FIG. 1C illustrates a switching network according to one embodiment of the present invention that couples a plurality of data object content providers (publishers) to a plurality of customer client computers, or users (subscribers);

FIG. 1D illustrates a switching network according to one embodiment of the present invention that couples a plurality of data object content providers (publishers) to a plurality of customer client computers, or users (subscribers) through an intermediate server;

FIG. 1E illustrates a switching network according to one embodiment of the present invention that couples a plurality of data object content providers (publishers) to a plurality of customer client computers, or users (subscribers) in which one or more of the subscribers may be coupled to a variety of client devices;

FIG. 2 is a block diagram of a computer network system that can be used to implement a data object delivery and billing system, according to one embodiment of the present invention;

FIG. 3A illustrates a communications platform based client server network system for continuous interactive communications that can be used to implement a data object delivery and billing system, according to one embodiment of the present invention;

FIG. 3B illustrates a communications platform based client server network system for continuous interactive communication that can be used to implement a data object delivery and billing system, according to an alternative embodiment of the present invention;

FIG. 4 is a flow diagram that illustrates the publisher, or data object content provider-side process for the electronic commerce system of FIG. 1, according to one embodiment of the present invention;

FIG. 5 is a flow diagram that illustrates the subscriber or user-side process for the electronic commerce system of FIG. 1, according to one embodiment of the present invention; and

FIG. 6 illustrates a network architecture for continuous interactive communication that implements a content delivery and billing system, according to one embodiment of the present invention.

### DETAILED DESCRIPTION OF THE PREFERRED EMBODIMENT

A network-based data object delivery and billing system for electronic commerce is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or standard telephone line. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers.

Aspects of the present invention can be used in a distributed electronic commerce application that includes a client/server network system that links one or more server computers to one or more client computers, as well as server computers to other server computers and client computers to other client computers. Typically users of the client computers access the server computers or other client computers to select and purchase products or services that are offered for sale by users of these computers. The product, billing, and shipping systems are typically maintained in databases stored in one or more server computers, or on client computers. Different entities may be responsible for different aspects of the transaction from the seller's side. For example, one company may be involved in the selling and shipping of product, while another is involved in the billing and collection of the finds from the buyer, such as a billing network operator.

In one embodiment, the distributed electronic commerce application includes a networked billing system that includes a switching network that couples a plurality of computers to one another. The switching network facilitates the delivery (transmission) and tracking of data objects and allows for the billing of these objects. For purposes of the following description, data objects represent digital data that are transmitted from one computer to another computer through the switching network, and may represent any type of digital content that is purchased, rented, leased, or otherwise downloaded and/or used in exchange for consideration. Such data may be referred to as “content”, “data product”, or other similar terms.

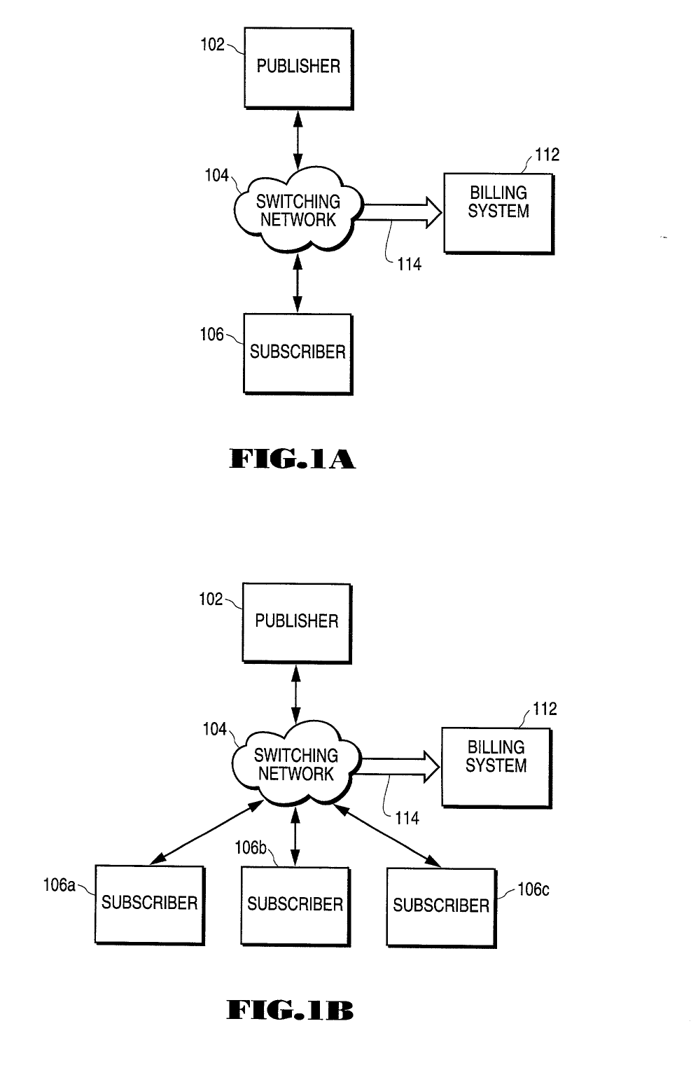

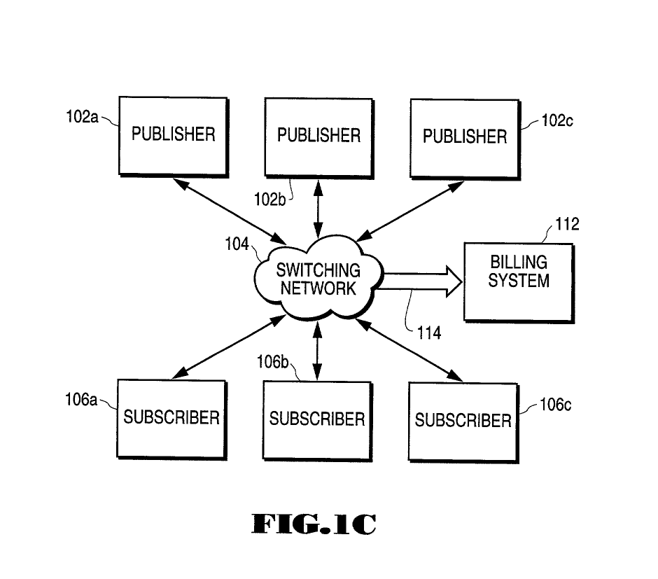

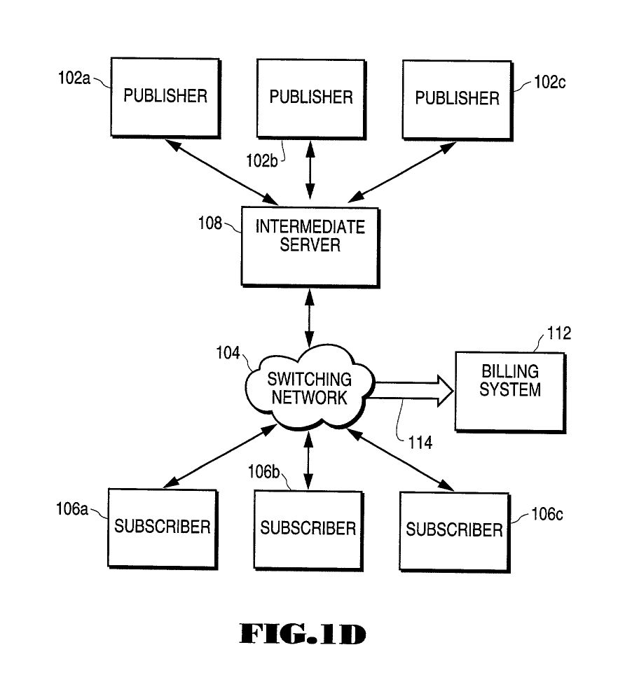

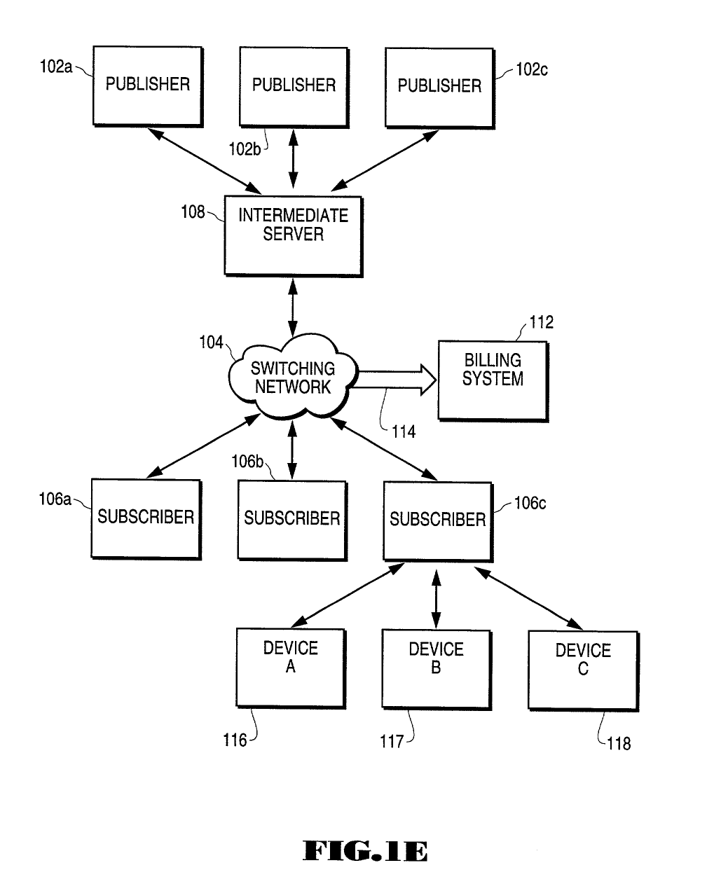

Several different network topologies may be implemented through the use of a distribution and billing system that utilizes a switching network according to embodiments of the present invention. FIG. 1A illustrates a network in which a content provider computer, referred to as a “publisher” 102 is coupled to a subscriber computer 106 through switching network 104. Typically, publisher 102 is a server computer that contains or is coupled to a content database, and subscriber 106 is a client computer that requests content to be downloaded from the publisher. Alternatively, content can be downloaded to the client computer when certain pre-defined events are met. The publisher may also be referred to as a “content provider”. The subscriber 106 may be a network computer or computing device that is operated by a user or individual; it may also be an application that uses the downloaded data and is executed by a network computer or computing device. Alternatively, either or both the publisher 102 and subscriber 106 computers may be client or server computers. As content data is downloaded from the publisher 102 to the subscriber 106, this data exchange is tracked and payment is transferred from the subscriber 106 to the publisher 102. The switching network 104 may also provide a gateway 114 to a billing system 112 that facilitates the ultimate billing and transfer of payment for the downloaded data.

FIG. 1B illustrates an embodiment of the network illustrated in FIG. 1A in which a single publisher 102 is coupled to more than one subscriber, denoted 106a, 106b, and 106c. Any or all of the subscribers may request the downloading of content data from publisher 102 over switching network 104 either directly or when pre-defined events occur. Similarly, more than one publisher may be available to provide content data to one or more subscribers. FIG. 1C illustrates an embodiment of the network illustrated in FIG. 1A in which a plurality of publishers, denoted 102a, 102b, and 102c are coupled to a plurality of subscribers 106a, 106b, and 106c through switching network 104. The publishers 102a-c may provide separate and distinct content data objects, or they may provide portions of a comprehensive data object to be downloaded to the one or more subscribers.

An intermediate server 108 may be provided for the embodiment in which content data is provided by several publishers 102a-c. This embodiment is illustrated in FIG. 1D. For this embodiment, the intermediate server 108 may receive different content data objects from the publishers 102a-c and package these objects for download to the subscribers according to specific packaging rules.

In one embodiment of the present invention, the content data downloaded to a particular subscriber may be directed to a particular type of subscriber network computing device. A subscriber may be coupled to the switching network 104 through any number of different network computing devices, such as a personal computer, personal digital assistant (PDA), cellular phone, or similar type of network device. FIG. 1E illustrates an embodiment of the network illustrated in FIG. 1D in which a subscriber 106c is coupled to, or implemented by, one or more different types of network computing devices denoted device A, 116, device B, 117, and device C, 118. For this embodiment, the content data downloaded to subscriber 106c is delivered to one or more devices according to predefined rules and may be modified according to the type of device that the content is ultimately directed to. For example, if device A, 116 is a cellular phone with a limited display capacity, the downloaded data object may comprise text data only, rather than graphics which are unable to be adequately displayed by the phone display.

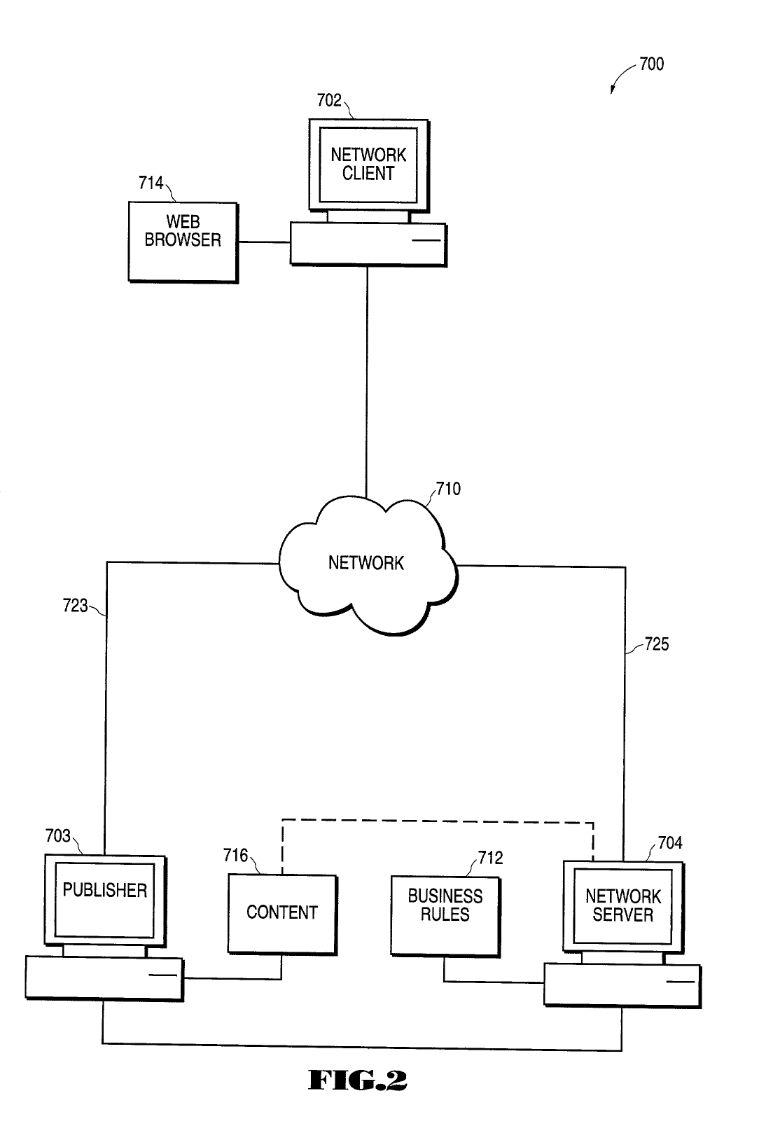

FIG. 2 is a block diagram of a computer network system that can be used to implement an object delivery and billing system, according to one embodiment of the present invention. The system 700 of FIG. 2 is a simplified illustration of a distributed electronic commerce system that can implement aspects of the present invention.

In system 700, a publisher computer 703 is coupled, directly or indirectly, to one or more network client computers 702 through a network 710. The network interface between publisher computer 703 and client computer 702 may also include one or more routers. The routers serve to buffer and route the data transmitted between the server and client computers. Network 710 may be the Internet, a Wide Area Network (WAN), a Local Area Network (LAN), intranet, extranet, wireless network, or any combination thereof, or any packet-based network. The network client 702 represents a computer or computing device operated by a subscriber, such as subscriber 106 in FIG. 1A.

The publisher computer 703 contains, or is coupled to a content data store 716. The publisher 703 makes this content available to the subscriber network client 702 over the network 710 in response to a download or purchase request from the subscriber, or in response to a predetermined event or time duration, such as an automatic periodic (e.g., daily) download. The content data is transmitted in the form of data objects, that represent digital media product that is either paid for by the subscriber or that otherwise constitutes part of a revenue bearing event that requires ultimate payment to the publisher 703. The business model that dictates the transmission of the data objects and payment for these objects may be maintained by a set of business rules defined and processed by the publisher 703. Payment from the subscriber to the publisher may be facilitated or accomplished through the use of a third party billing system or financial entity that may also be coupled to network 710, such as billing system 112 illustrated in FIG. 1A.

The embodiment illustrated in FIG. 2 includes a network server 704 that is coupled to network 710. Network server 704 represents an intermediate server 108, shown in FIG. 1D, that may serve to aggregate content data from one or more publishers 703. In this manner, the network server 704 may be directly or indirectly coupled to the content 716 that is provided by the publisher 703. The network server 704 accesses business rules 712 that dictate the transmission of the content from the publisher 703 to the subscriber 702. These business rules 712 may also include routing and tracking processes that serve to direct the content data to the appropriate subscriber device or application program, as well as billing processes that facilitate payment from the subscriber to the publisher. In one embodiment of the present invention, the network 710 and the network server 704 together constitute a portion of the switching network 104 illustrated in FIG. 1A.

Although FIG. 2 illustrates the various computers coupled to network 710 as client or server computers, it should be noted that the publisher and subscriber network entities can be implemented in any type of network computing device that is capable of performing client and/or server functions when coupled to a network. Moreover, network 710 may be a public network in which any publisher can access the network, and similarly any user or application can access the network. Such a network could be a public wide or local area network, or it could be the Internet, or a network that runs alongside the Internet.

In one embodiment of the present invention, the publisher 703 and/or network server 704 are implemented as a World-Wide Web (WWW) servers that store data in the form of ‘Web pages’ and transmit these pages as Hypertext Markup Language (HTML) files over the Internet network 710 to the one or more of the client computers 702. For this embodiment, the client computer 702 runs a “Web browser” program 714 to access the Web pages served by publisher 703. For this embodiment, network server 704, or a similar server within network 710 may include a Web adapter that facilitates the routing and switching of the data objects embodying the Web pages or HTML data to the appropriate subscribers. This data object switch process comprises the content delivery and billing system described in relation to the network implementation illustrated in FIGS. 1A-1E.

In an alternative embodiment, communication among the various server and client computers is not implemented via a Web-based interface. For example, content data, such as rich media files can be transmitted to a non-PC device that does not execute a Web browser program. Such data can be transmitted to a particular application program that interprets the data.

For the system illustrated in FIG. 2, the server computer 704 may include an account managing process that stores data relevant to commercial transactions with various subscribers network clients 702. The server 704 can provide access to a database of available content data, products and/or services that can be purchased by subscribers (customers). Such a database may be available locally on server 704 or through the publisher 703. In this case, the link between publisher 703 may be a direct link to server 704, or it may be in indirect link through network 710. The business rules 712 maintained by either the publisher or server 704 to evaluate the purchase requests from the subscribers and provide content in response to a request or download of content data. The server and/or publisher may also store account information regarding the identity, billing history, shipping information, and other information regarding each customer. New customers have the opportunity to set up client accounts maintained by the server to establish a billing structure to manage their transactions. Suppliers of the content objects (i.e., other publishers) may also have the opportunity to set up accounts to manage the billing process, set prices and payment terms, and so on.

In one embodiment of the present invention, server 704 in network system 700 includes a data delivery process that is configured to handle data download requests or product orders from a customer. For this embodiment, the publisher 703 publishes or posts the content data to the network server 704 or other server within the switching network. The network server then distributes the content data to the appropriate subscribers. It should be noted, that the term “data” or “product data” refers generically to any type of content, data object, or collection of data transmitted among the client and server computers, and that is considered revenue bearing data or content that is part of a greater overall financial relationship between the publisher and subscriber.

In one embodiment of the present invention, the network server 704 makes up part of the switching network between the subscribers and publishers. Delivery of content data from a publisher to a subscriber may be explicitly requested by a subscriber, such as through a “purchase” command provided on an interface screen or Web page. Alternatively, the content data may be delivered automatically to a subscriber upon the occurrence of a predetermined event, such as a weekly or daily subscription service, e.g., receiving stock quotes hourly or daily. The server 704 maintains rules and filters that dictate the transmission of data from the publishers to the subscribers based on the identification of the subscribers, the payment for the data, and/or the occurrence of the predetermined events. Typically, upon a download request or event, the content product is parsed into its principal component objects. These objects thus include information that specifies the identity of the requestor and the type of device that the customer is using (client computer device). The business logic that specifies the type of business rule or rules that are to be applied to the transaction request reside on either the publisher or network server computer, or on the subscriber client computer at the application level.

The client computer that is utilized by a customer can be one of a number of different network computing devices, including Web-based Internet devices, such as a standard personal computer, a Web-enabled cell phone, a personal digital assistant (PDA) device, a network appliance (“toaster”) device, or any similar type of client computing device. In some cases, the client computer may execute an application that automatically requests the data without the need for user input or intervention.

Aspects of the data object delivery and data transaction model utilized in embodiments of the present invention are described in the above-referenced U.S. patent application, entitled “Method and System for Continuous Interactive Communication in an Electronic Network”, that is assigned to the assignee of the present application, and that is hereby incorporated by reference. For this embodiment, the interface between the customer client computer 702 and the publisher 703 is accomplished through an intermediate communications platform that includes a network server 104 that forms part of the switching network.

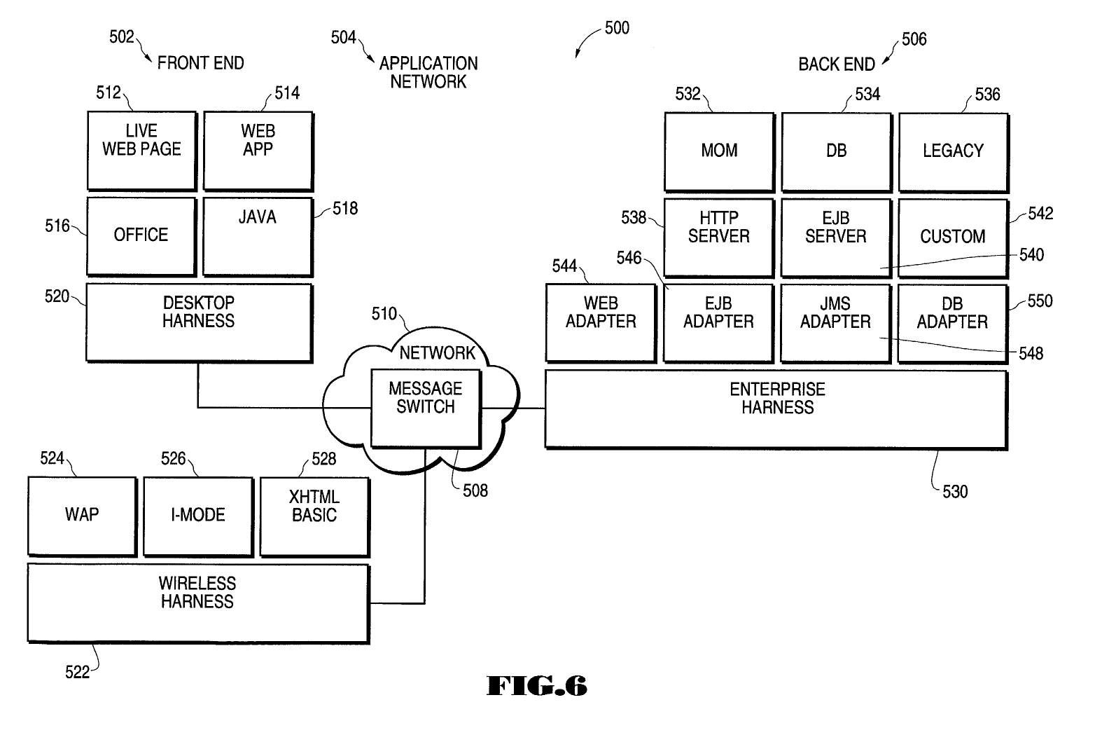

FIG. 6 illustrates a network architecture that can be used to implement the data distribution and billing methods according to embodiments of the present invention. The network architecture illustrated in system 500 comprises the three major components of a front end 502, application network 504, and a back end 506. The front end 502 represents a user client device, client computer, PDA, cell phone, or other type of networked computing device. Hardwired client devices are coupled to the network 510 through a desktop harness 520 that provides an interface to various client processes, such as Web browser pages 512, Web applications 514, Java interface 518 or Office or other program interfaces 516. Wireless client devices (e.g., cell phones or PDA's) couple to network 510 through a wireless harness 522. The wireless harness 522 provides access various wireless application programs, such as WAP 524, I-mode 526, and XHTML basic processes 528.

The desktop harness 520 includes an interface with defined connectors that allows the front end to connect to network 510. Similarly, the enterprise harness 530 includes an interface with defined connectors that allows the back end to connect to network 510.

The back end 506 component of system 500 represents the system associated with the content providers and/or publishers. This component comprises an enterprise harness 530 that couples the network 510 to various back end processes, servers and databases. These include, but are not limited to, an HTTP server 538, EJB server 540, as well as custom servers 542. These servers access various databases and legacy objects 532, 534, and 536. The backend 506 also includes various adapters, such as Web adapter 544, EJB adapter 546, JMS adapter 548, and database adapter 550.

The client front end 502 and publisher/content provider back end 506 systems are coupled through application network 504 that is built on network 510. This network includes a message switch 508 that routes content to the client devices using various parameters, such as device type, client (user) identification, data type, topic, and so on. The application network 504 includes several processes and functions that enable aspects of the present invention. These include a store and forward function that allows the client device to access data from the back end servers, as well as conduct transactions with these servers without requiring a live network connection at the time the transaction is initiated or received/accepted. The application network also processes the transmitted data objects on a granular level that allows intelligent routing through the message switch 508. This allows for dynamic routing of the data depending upon the parameters listed above, as well as multiplexing of data from various servers to a single client device, or devices assigned to a single user. It also allows for multiplexing of content requests from multiple users to a single publisher or group of publishers. The granularity function breaks the data objects down into component parts and provides a message header for each component for arbitrary data payloads. That is, the data payload can be in any type of format, e.g., text, video, voice, and so on. The message switch can then route the data to the appropriate client through an addressing scheme that differentiates by user ID, topic, and device type. Details of these aspects of the present invention are provided in greater depth in the above-referenced U.S. patent entitled “Method and System for Continuous Interactive Communication in an Electronic Network”.

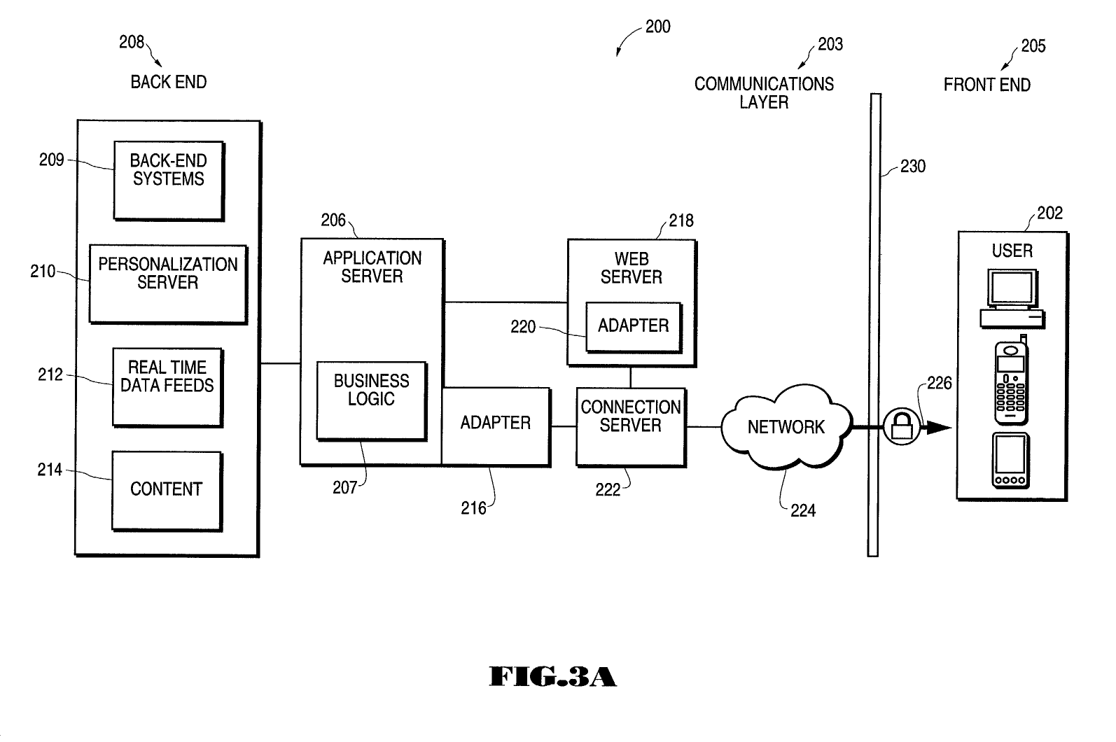

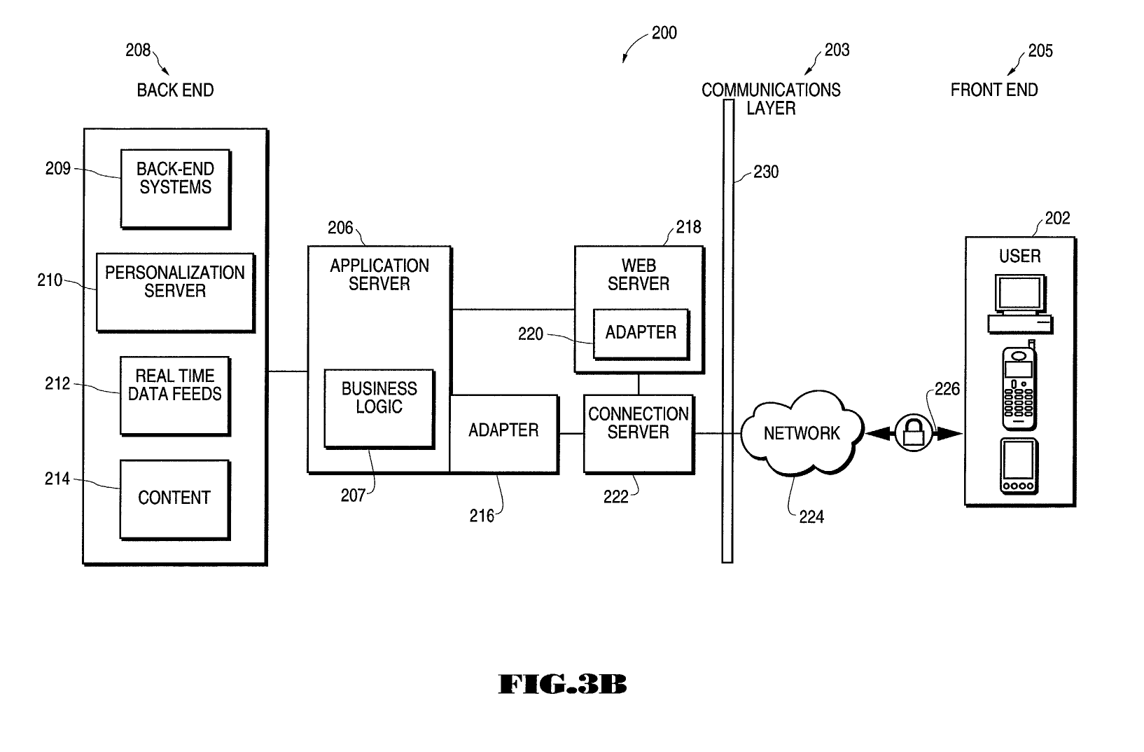

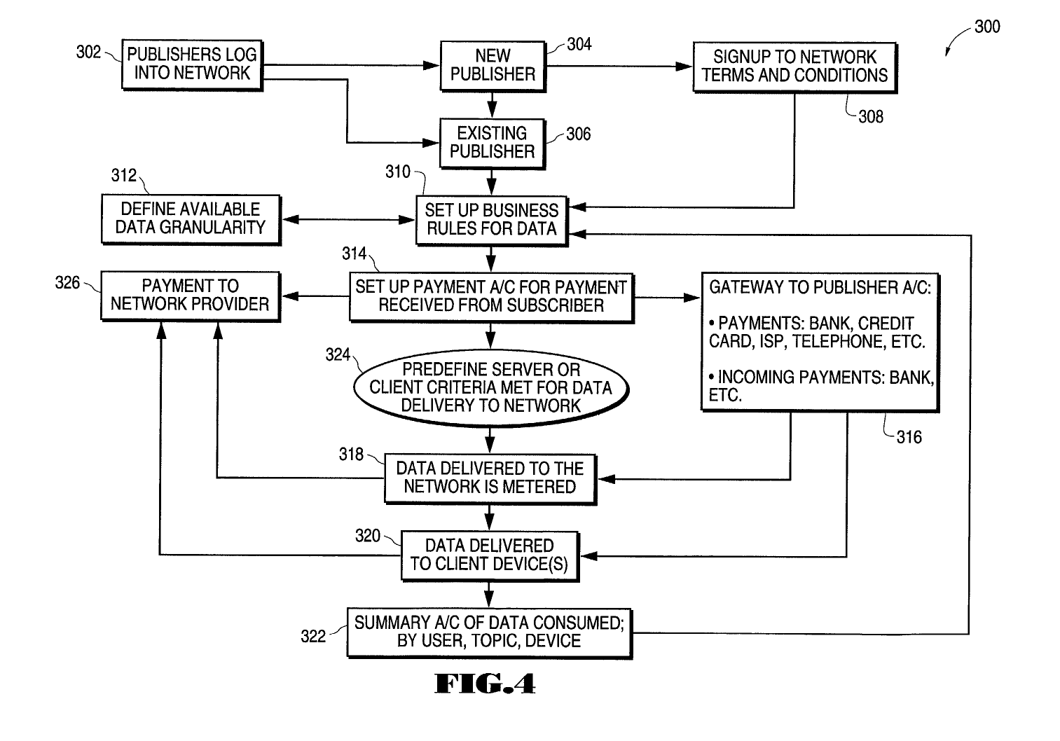

FIG. 3A illustrates a communications platform based client-server network system that can be used to implement a data object delivery and billing system, according to one embodiment of the present invention, whereby the switching network is delivered as a service hosted by a third party entity. For the embodiment illustrated in FIG. 3A, the switching network is delivered a packaged product to entities who want to deploy their own data object content delivery and billing network. The system illustrated in FIG. 3A illustrates a data distribution and bill processing instance of the generic architecture illustrated in FIG. 6. System 200 comprises the three main components of back end 208 coupled to front end 205 through a communications layer 203. The front end 205 comprises a user client computing device that may be a personal computer, PDA, cell phone, or any other type of internet-enabled client device.

The back end component 208 comprises the back end systems 209 associated with the content provider or publisher servers. These include personalization server 210, real time data feeds 212, and content 214. The back end 208 also includes an application server 206 that, in turn, includes several server processes, such as business logic process 207. In one embodiment, the application server 206 is coupled to a Web server process 218 that includes an adapter 220. The application server may also include or be coupled to other adapters 216, depending upon the actual implementation, this may include an EJB adapter. The Web adapter and/or EJB adapter are coupled to the network 224 through a connection server 222.

For embodiments in which the network connection is over the Web, connection between the application server 206 and the front end is through Web server 218. Adapter 220 couples Web server 218 to the network 224 via connection server 222. For embodiments in which the network connection is over a different protocol, the application server is coupled to the front end through connection server 222. The connection server may then be directly coupled to the network 224.

The communications layer 203 comprises the appropriate network protocols to allow communication between the client front end 205 and the server back end 208 over network 224. The communications layer allows secure (locked) communications over any network link 226. For example, the communication link 226 may be implemented as an IP/HTTP link. For the embodiment illustrated in FIG. 2A, a firewall 230 is provided between the network 224 and the front end 205 client devices 202.

As stated above with reference to FIG. 6, the communication platform that couples the user 202 to the application server 206 includes several processes that support full interactivity and continuous availability in communications between the user (subscriber) and application server in the client/server or client/client network. The application server can send data to the client computer at any time, with no need to wait for user requests. The server and end user device can communicate at any time. The user need not be executing an active Web browser application to access the server, and the server can download content to the user(s) at any time. The communication platform also includes an error checking process that executes error check procedures, data transfer retries, and error correction processes to overcome network communication problems. The communication platform incorporates a Store and Forward messaging infrastructure to provide event-driven delivery of objects between application elements. Objects are given to the system for delivery to a specified address or group of addresses. They are accepted and stored until delivery is possible. Upon delivery, they are passed immediately onto the appropriate destination application element. Objects can be transformed from one representation to another within the messaging infrastructure, if requested by the sender or recipient.

FIG. 3B illustrates a communications platform based client-server network system that can be used to implement an object delivery and billing system, according to one embodiment of the present invention. For the embodiment illustrated in FIG. 3A, the object delivery and billing network is assumed to be delivered as a hosted third party service. The system illustrated in FIG. 3B is essentially identical to that illustrated in FIG. 3A except for the functional location of the firewall 230, which is placed between the communication layer 203 and the back end 208. Distribution of the data as a product, as illustrated in FIG. 3B may be provided in situations in which third parties desire to purchase and implement a message switching and billing service as part of their own service or as part of an internal network.

In a comprehensive distributed network with several content providers and client device users, the users may purchase and access data from one or more content providers. The back end component 208 comprising the back end systems 209, the application server 206 and the Web or connection servers 218 and 222 represent the key components for each content provider. The back end and front end components 208 and 205 are considered to be network nodes on the communication platform. Content data can be routed between any node. In this manner, content originating from one client can be routed through the switching network to another client and/or application. A user may access different types of data from various content providers, for example audio content from an audio content provider (e.g., an on-line radio Web site) and video from a video content provider (an on-line TV station Web site). In one embodiment, this transaction is managed by a data distribution management server that is embodied within the communications layer 203 (switch). This data distribution management server can package the content for distribution to the client device and aggregate the billing price for the content, as well as manage payment from the user to the content providers based on tracking that is associated with the switch. The granular feature of the communications layer allows for intelligent routing of the data from the content providers to the client device, either directly or through the data distribution management server. Likewise, the store and forward feature of the data distribution management server allows the content providers to publish the content to the network regardless of the connection status of the client device. Using a store and forward queue, the user can access the published data once the user logs onto the network through the client device.

FIG. 2 represents a generalized network diagram in which the product or content data 716 is provided by a separate publisher 703. The publisher server 703 represents a content provider that is ultimately responsible for providing the requested content to the customer. As mentioned previously, the data may be explicitly requested from the customer, or it may be requested by an automated process that responds to a predetermined event, such as a date/time trigger. The network server 704 executes a download of requested content from the contents database 716 that is stored internally or externally to the publisher server 703. Along with processing requests for downloading of content data, the network server 704 may also retrieve the requesting customer data from a customer database and attach it to the requested primary contents or use it to modify content or transmission parameters for particular users. This data is then transmitted from the publisher 703 via the network 710. The network server 704 may be configured to transmit content data to several different customer client computers that have a common product request. For example, such an application can be used to fulfill on-line or hardcopy magazine subscriptions or similar widely distributed periodical products.

In one embodiment of the present invention, wherein network 710 is the Internet, one or both of the servers 703 and 704 execute Web server processes to provide HTML documents to client computers coupled to network 710. To access the HTML files provided by the Web servers, client computer 702 runs a Web client process (typically a Web browser or a portion of browser, such as the HTML rendering engine) 714 that accesses and provides links to Web pages available on the servers and other Internet server sites. In general, the client process may have access to any type of data and business processes available on the publisher 703 or network server 704. It should be noted that a network system 700 that implements embodiments of the present invention may include a larger number of interconnected client and server computers than shown in FIG. 2. Moreover, system 700 in FIG. 1 anticipates larger interconnected network systems in which multiple client computers are coupled to one another and multiple server computers are coupled to one another.

The network 710 is normally a bi-directional digital communications network that connects the user's terminal hardware with the data distribution management server provided on the server side of the system. Some examples of existing network infrastructures include CATV (cable television) bi-directional network, ISDN (Integrated Services Digital Network), DSL (Digital Subscriber Line), or xDSL high-speed networks.

For purposes of the following description, the term “customer” includes any party that consumes data within the transaction system 700, and the term “content” includes revenue bearing data (e.g., ‘for pay data’ or data provided as part of a broader financial relationship) delivered across the system 700. In some cases, a customer can also be a publisher. System 700 is a simplified diagram of an aggregated marketplace of publishers and consumers. The term “content data” in the context of the specification and claims shall be understood to refer to any type of downloadable data, which may consist of any one of text data, video linear streaming data, such as motion picture data in MPEG or MPEG2 format; linear audio streaming data, such as music data in MP3 format; binary program data; voice data; or any combination of such data or similar data. In general, content data does not include services or data that are used solely to provide access to a network, such as browser software or protocol handlers whose main function is only to establish a network connection.

The system of FIG. 2 allows the implementation of an entire billing system across a WAN (Internet or other Wide Area Network) whereby a publisher can bill an end user or customer based on consumption of content at a very granular level. Such a granular level includes a description of the content type, customer parameters (e.g., location, purchase history, preferences, credit rating, and so on), and customer client computer device type, even in real time. A publisher can be any entity that provides content to one or more customers. The content could be any electronic data that is transmitted to the client computer over the network 710. Alternatively, the content could be non-electronic products or services that the publisher causes to be delivered to the user upon successful completion of the purchase transaction.

A publisher can dynamically create content from multiple sources and aggregate billing in real-time. For example, a publisher could obtain music content data from a first company and associated review information from a second company, and then combine the product offering to the customer with an aggregated billing statement. The publisher may have different credit terms for each of companies, for example, payment is not forwarded to the second company until 30 days after consumption and 60 days for the first company. The billing platform within the business rules of the network server 704 can be configured to recognize this. The billing system can also be configured to allow the publisher to sell content to the customer, and have the customer agree to and pay for its consumption (offline) at one time, and deliver that content at another time.

In one embodiment, a publisher, or other entity on the network, provides a Web-based interface that allows self-publication of available contents and a definition of the granular level access rights to that content across the network. For example, the interface will display certain requirements and restrictions, such as, age restrictions, payment terms, and so on. The interface could also allow tiered pricing structures and tiered service level agreements on a customer, content topic, or device level. For example, signing up for the same news alerts could carry different pricing regimes depending upon the user's client device. For instance, if the subscribed product is periodical news information, and the user receives the data on a personal computer, the full news stories are transmitted so full fees are charged; on a cell phone only headlines are received, so the fee is reduced. Publishers could also establish pricing regimes based on the publication date of the contents. For example, news headlines may cost consumers 30 cents on the day they are published and only ten cents on the next day, because of the time value of the data. This is achieved by cross-referencing a content time stamp with a database that stores dynamic pricing information for the related content (e.g., x hours after publishing price=$2, x+1 hours after publishing price=$1, and so on).

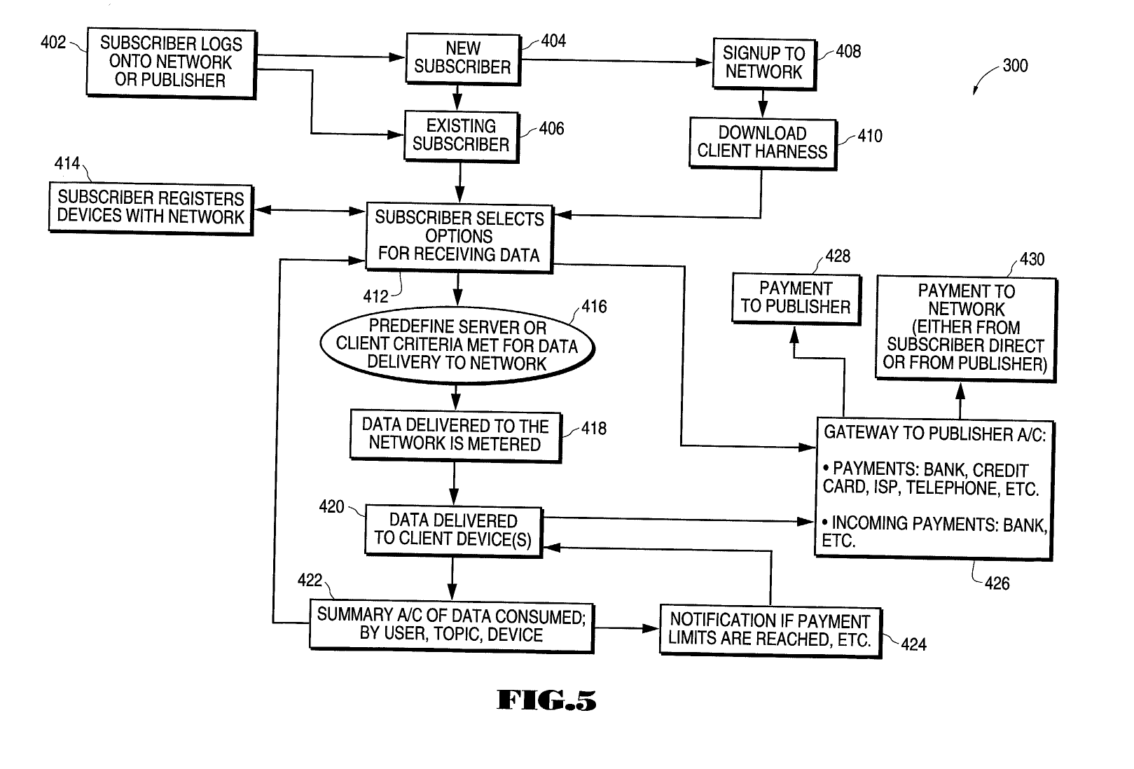

FIG. 4 is a flow diagram that illustrates the publisher-side process for the electronic commerce system of FIG. 2, according to one embodiment of the present invention. For the flow diagram of FIG. 4, a network is established for a number of different publishers. The network allows the publishers to provide content to users and bill the users based on specific usage parameters. In step 302, a publisher logs into the network and it is established whether it is a new 304 or existing 306 publisher. The publisher then signs up to the networks Terms and Conditions, step 308. The publisher then establishes and specifies the relevant business rules for the data, step 310. This can include the price, payment terms, access restrictions, and other data specific information. In step 312, the publisher defines the available data granularity, that can include user identification (age, gender, address, etc), topic, client device, and other user-specific information. It should be noted that there may be different classes of publishers or content providers. For example, one type of publisher (supplier) may only be able to provide certain types or amounts of information, for example headlines from news reports, while other types of publishers may be able to provide an entire range of data.

Once the publisher has set up the business rules, the payment account for money received from the customers is established, step 314. The payment account can be set up in one of several ways, payment to a gateway entity, step 316 or payment from and to the network provider 326. A gateway entity can be a bank or similar financial institution. In this case outgoing payments can be performed using various billing methods or credit instruments, while incoming payments can be provided by a bank or other financial institution. If the payment account is set up with the network server, predefined server or client criteria must first be met for data delivery to the network, step 324. Such criteria may include spending limits, product or service restrictions, customer age restrictions, geographical controls, and so on, either set by the publisher or the customer.

Once the payment account is properly established, the data is delivered to the client device, step 320. In some cases, the data may be transmitted from one client to another client, or between different servers, depending upon the data distribution model. In some instances, publishers may allow data to be shared between the customer's client devices for no additional charge, in other cases additional charges may be incurred. The data delivered to the network is also metered, step 318. Payment is then provided to the network provider, step 326. The publisher may pay the network operator once the data is published to the network, or there may be a tiered payment scheme in which an initial payment is made upon publication to the network with a final payment due when the data is accessed by the end user or client device. As illustrated in FIG. 1A, a gateway may be provided to third party billing services or companies for facilitation of payment transactions.

A summary of the data consumed by user, client device, and so on is collected and made available to the publisher who may use this data to alter the business rules, step 322. Depending upon the implementation details, certain information mapped to an individual user may not be supplied to protect the privacy of users and/or publishers. In this case, arbitrary identifiers may be provided to tag user feedback data. This provides feedback of relevant product and user information so that future transactions can be modified accordingly. Because the network architecture illustrated in FIGS. 2, 3A, and 3B is transactional, there is guaranteed receipt of the digital content, including associated auditing. This feature is useful in identification of problems and dispute resolution. This notification to the publisher of content receipt (or consumption) by the consumer could also occur in real-time at the time of acknowledged receipt or consumption. The metering of data delivered to the network and the reporting of the summary account data facilitates this feature. The billing system could also generate granular reports for publishers allowing them to segment preferred customers and offer them price incentives and bundled offers.

FIG. 5 is a flow diagram that illustrates the subscriber-side process for the electronic commerce system of FIG. 1, according to one embodiment of the present invention. In step 402, a subscriber (customer) logs into the network and it is established whether it is a new 404 or existing 406 subscriber. The subscriber then signs up to the network, step 408, and downloads a client harness, step 410. The subscriber then selects options for receiving the data. Such options can include the type of client device to download the contents to (e.g., cell phone, PDA, computer), the appropriate download times, transfer rates, maximum file sizes, and so on, step 412. This ensures that the billing system is device independent. In step 412, the subscriber also specifies the payment method he or she would like to use. The subscriber then register the possible client device or devices with the network, step 414. Previously registered devices may be displayed for selection by the subscriber.

In step 416, it is determined whether relevant predefined server or client criteria are met for data delivery to the network. In step 420 the data is delivered to the subscriber's client device, and the delivered data is metered, step 418. In certain cases, the user can forward the data from one client device to another client device controlled by the user, for example, downloading the data from the user's desktop computer to a laptop computer or PDA. The customer can also set up ‘follow me rules’ for certain data. For example, certain kinds of data might be identified as high priority by the customer. This high priority data is first delivered to one device and then if receipt is not acknowledged it is delivered to another device. Alternatively, if a device is not connected to the network, the data may be delivered to one or more other client devices owned by the customer. The network can be configured to provide digital rights management to ensure that predefined downloads among a single user's client devices is allowed, but downloads among different users is restricted. For example, a user could download a video clip to a set top box and then forward it to their own computer, but would be not permitted to forward it to anyone else's computer.

The payment is then made from the subscriber to the publisher, step 428 via the network. In some cases, a gateway may be provided through which payment is made, step 426. For this embodiment, the billing system operator (network) carries no risk or float in acting as an intermediary. The consumer or credit card company carries the risk where appropriate. Payment may also be made directly to the network from the subscriber, step 430. In step 422, a summary of the data consumed by the subscriber is registered. If the subscriber has established a particular type of payment account, a notification is issued if payment limits are reached, or if other similar restrictions are met, step 424.

In one embodiment, the account server that processes the subscriber account and payment information can be configured to allow various processing and filtering functions for the users. For example, customers could link account information for billing, to other applications with instructions to synchronize in real time, this account information whenever there is a change. For example, if a mailing address is changed in a junk mail filter application, this change is reflected in real time in the billing system, and all other predefined, relevant applications as specified by the consumer and the publisher. The customer can be provided with the ability to move money around on the client device with client message store capabilities.

It should be noted that, using the store and forward capabilities of the network system illustrated in FIGS. 3A and 3B, data can be accessed by the user, and payment made for the data objects even when the client device is not connected to the network.

Filters could be established on the client restricting subscription and payment to particular predefined content and publishers, i.e., content type (e.g., content filters to protect children from adult content), size of content file or message, author of content, and so on. Similarly, filters could be established within the network so that customers can receive notification if data objects are available that are outside normal access controls. For example, if a customer has signed up for a subscription that entails monthly payments to access corporate competitive intelligence data, using the network and associated filters, the customer can request a premium corporate credit analysis of a trading partner that is not accessible as part of the subscription, therefore additional payment over and above flat-rate subscription is required before content is delivered. The subscriber account can be configured to allow for multiple billing accounts per device and also the ability to aggregate billing per device, per consumer or for a predefined group of consumers, such as a particular department within a company.

The customer can also set up a filter to halt acceptance of content once a predefined monetary level had been reached for a specified time period. This can be useful for corporate control of purchases of digital assets. Similarly publishers could be configured to notify customers when a predefined limit had been reached. Using the same client side filters, the customer could designate that payment related messages get routed directly to financial management application within the corporation. This prevents the need for personnel, such as the finance department, to re-key any of the transaction related data. Customers could also use filters to determine what other entities, if any, could be given access to transaction details associated with the purchase of contents, or allow limited access to certain transaction records and not other transaction records.

Because the billing system acts as an intermediary, the true identity of the customer could be concealed from the publisher. Anonymity is an important component of monetary systems and is a feature that is absent from many current online payment systems.

In one embodiment, the publisher interface includes a one-click purchase icon to facilitate payment by the subscriber, and to notify the customer that the publisher is part of the billing network. For example, a content delivery and billing network icon can be provided so that the customer knows that the publisher is part of the network and the purchase will automatically be recorded as part of the network. The customer could be notified in real-time of current account balances from the billing network in aggregate (using the billing system), and also of account balances in other predefined accounts. For example, a customer can purchase a book online and click a ‘Buy Now’ icon on the interface. The billing system account balance is then displayed alongside the customer's current credit card account balance and any other financial account balances. This feature allows a consumer to gain complete view of his/her current financial situation when deciding whether or not to make a purchase. Another interface feature could include a currency translator that translates purchase prices from one currency into another in real time, thus informing the consumer what the payment levels will be in the foreign currency.

With reference to FIGS. 1A to 1E, the implementation of a switching network to implement embodiments of the message switching and billing network is typically accomplished through the definition and provision of connectors provided to publishers desiring to connect to the switching network 104. The connectors are provided in the form of one or more interfaces to the network server. The connectors allow the publishers to connect to the switching network through defined network ports. They also help define objects that the switching circuits within the network can recognize. The interfaces provide means by which the publishers can define prices, terms, and conditions of sale, filters, and other parameters pertinent to their content data download service or product. Rules may be defined and maintained by various entities in the network. For example, in FIG. 1D, a first set of rules may be maintained by the publisher 102, a second set of rules may be maintained by the intermediate server 108, and a third set of rules may be maintained by the subscriber 106.

In one embodiment of the present invention, the billing system incorporates various data transmission security schemes, such as digital signature technology and private/public key systems. For this embodiment, the network incorporates various aspects of the security, authentication, and access controls associated with the systems illustrated in FIGS. 3A and 3B.

Although the embodiment illustrated in FIGS. 4 and 5 described aspects of the present invention in the context of a publisher content provider, it should be noted that other types of sellers or content providers are also possible. For example, companies that sell products that are not in computer data form, or that provide services, can also set up billing accounts to provide their products/services to subscribed user.

The data delivery and billing network can also be used for embedded systems. For example, an engine management system in a car may take the form of a publisher, publishing engine status data to the network. Customers of this data may be automotive service companies. Part of the data published by the engine management system may include mechanical repairs required and prices that the owner of the vehicle are willing to pay for these repairs. The automotive service companies could subscribe to this kind of data in accordance with pre-defined rules, e.g., make of car, geographic location, service pricing levels/minimums, and so on. If all criteria are met, the automotive service company could publish interest to the engine management system via the network to perform the repairs. If the pre-defined criteria for the engine management system are met as part of this registered interest on the part of the automotive service company, then a confirmation is sent back to automotive service company and the repairs are scheduled. Alternatively the repairs could be performed automatically if the repairs involve only data, or can be performed remotely via the network.

In the foregoing, a system has been described for transmitting content data and providing billing support among various networked computer users. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method for transmitting content data over a computer network comprising the steps of:
providing a first interface to a publisher to define content data objects;
providing a second interface to a user of a client computer to select content data objects from the publisher;
providing a third interface to the publisher and the user of the client computer to select payment terms and conditions for the transmission of content data objects from the publisher to the user;
providing a switching network to transmit content data objects from the publisher to the user upon request from the user; and
managing a billing process for causing transfer of payment from the user to the publisher in exchange for transmission of requested content data objects.

2. The method of claim 1 wherein the content data objects are transmitted from the publisher to the user upon a specific request issued by the user.

3. The method of claim 1 wherein the content data objects are transmitted from the publisher to the user upon the occurrence of a predetermined event.

4. The method of claim 1 wherein the content data objects are processed for transmission according to a type of client computing device operated by the user to access the content data objects.

5. The method of claim 1 further comprising the step of determining the payment due to the publisher from the user depending upon a type of content data object requested by the user.

6. The method of claim 5 further comprising the step of determining the payment due to the publisher from the user depending upon one or more characteristics associated with the user.

7. The method of claim 6 wherein the one or more characteristics associated with the user comprise at least one of user identification, user credit rating, user payment history, and user geographical location.

8. The method of claim 1 further comprising the step of providing a gateway to a third party billing system for transmission of payment from the user to the publisher.

9. The method of claim 1 further comprising the steps of:
providing the first interface to a plurality of publishers, each defining different content data objects; and
providing the second interface to a plurality of users of client computers, each capable of selecting content data objects from one or more of the plurality of publishers.

10. The method of claim 9 further comprising the step of aggregating content data objects from one or more of the plurality of publishers in response to the request from the user.

11. The method of claim 10 further comprising the step of causing transfer of payments from the user to the one or more of the plurality of publishers in accordance to respective proportions of contributed content data objects transmitted to the user.

12. The method of claim 1 wherein the content data objects comprise one of digital text data, digital audio data, digital video data, and computer program data.

13. The method of claim 12 wherein the network comprises a wide area network coupling the publisher to the user client computer.

14. The method of claim 1 wherein the network comprises an embedded system coupling the publisher to the user client computer, and wherein the publisher comprises an embedded computing device capable of automatically generating content data objects.

15. The method of claim 1 wherein the network comprises an embedded system coupling the publisher to the user client computer, and wherein the client computer comprises an embedded computing device capable of automatically generating content data objects.

16. A method of delivering on-line content data to one or more client computers from a server computer over bi-directional communications network, comprising:
receiving a customer order for a product;
compiling the product from component objects provided by one or more content provider computers;
determining a plurality of customer identification and use parameters;
determining a client computing device operated by the customer to access the product;
aggregating the product price based on the price of the component objects from the one or more content provider server computers;
delivering the product to the customer in accordance with requirements of the client computing device and the customer identification and use parameters; and
billing a single payment amount based on the product cost to the customer.

17. The method of claim 16 wherein the single payment amount depends upon one or more customer identification and use parameters.

18. The method of claim 17 wherein at least one of the one or more content provider computers is a publisher computer that provides periodic electronic data products, and wherein the single payment amount depends upon a time of delivery to the customer.

19. The method of claim 18 further comprising the steps of:
providing a portion of the product to the customer; and
reducing the single payment amount by a proportional value of the portion of the product.

20. The method of claim 16, wherein the product comprises one of computer text data, audio data, and video data.

21. The method of claim 16 wherein the client computing device comprises one of a personal computer, handheld personal digital assistant, and networkable cellular phone.

22. The method of claim 16 wherein the bi-directional communications network comprises the Internet, and wherein the product comprises content HTML data.

23. The method of claim 16 wherein the bi-directional communications network comprises the Internet, and wherein the product comprises content XML data.

24. The method of claim 16 further comprising the step of distributing a corresponding portion of the payment amount received from the customer to each content provider in accordance with their respective contribution to the product.

25. The method of claim 24 wherein the payment amount is distributed to each content provider through a financial gateway entity.

26. The method of claim 16 wherein the client computing device comprises an application program executed by computing device.

27. A server computer coupled to one or more content provider computers, each operated by a publisher, and coupled to one or more client computers, each operated by a user, the server computer comprising:
first interface provided to each publisher to define content data objects;
a second interface provided to each user to select content data objects from a publisher;
a third interface provided to each publisher and each user to select payment terms and conditions for the transmission of content data objects from a publisher to a user;
a fourth interface to a switching network for transmission of content data objects from a publisher to a user upon request from the user; and
a billing process for causing transfer of payment from a user to a publisher in exchange for transmission of requested content data objects.

28. The server computer of claim 27 wherein the content data objects are transmitted from the publisher to the user upon a specific download request issued by the user.

29. The server computer of claim 27 wherein the content data objects are transmitted from the publisher to the user upon the occurrence of a predetermined event.

30. The server computer of claim 27 wherein the content data objects are processed for transmission according to a type of client computing device operated by a user to access the content data objects.

31. The server computer of claim 27 wherein the billing process determines the payment due to a publisher from a user depending upon a type of content data object requested by the user.

32. The server computer of claim 31 wherein the billing process determines the payment due to the publisher from the user depending upon one or more characteristics associated with the user.

33. The server computer of claim 32 wherein the one or more characteristics associated with the user comprise at least one of user identification, user credit rating, user payment history, and user geographical location.

34. The server computer of claim 27 further comprising a gateway interface to a third party billing system for transmission of payment from the user to the publisher.

35. The server computer of claim 27 further comprising an aggregating process for combining content data objects from one or more of the plurality of publishers in response to the request from a user.

36. The server computer of claim 35 wherein the billing process causes a transfer of payments from the user to the one or more of the plurality of publishers in accordance to respective proportions of contributed content data objects transmitted to the user.

37. The server computer of claim 27 wherein the content data objects comprise one of digital text data, digital audio data, digital video data, and computer program data.

38. The server computer of claim 27 wherein the switching network comprises a wide area network coupling the publisher to the user client computer.

39. The server computer of claim 27 wherein the switching network comprises an embedded system coupling the one or more content provider computers to the one or more client computers, and wherein a publisher comprises an embedded computing device capable of automatically generating content data objects.

40. The server computer of claim 27 wherein the switching network comprises an embedded system coupling the one or more content provider computers to the one or more client computers, and wherein a client computer comprises an embedded computing device capable of automatically generating content data objects.
